(19) United States
(12) Patent Application Publication
(10) Pub. No.: US 2010/0203972 A1
(43) Pub. Date: Aug. 12, 2010

(54) METHOD AND SYSTEM FOR MOBILE GAME USING LOCATION-BASED SERVICE

(75) Inventor: Tae Hoon LEE, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/700,836

(22) Filed: Feb. 5, 2010

(30) Foreign Application Priority Data
Feb. 11, 2009 (KR) 10-2009-0010990

(51) Int. Cl. A63F 13/12; G08B 5/22

(52) U.S. Cl. 463/42; 340/825.49

(57) ABSTRACT

A method and a system for a mobile game using an actual location-based service of the users as a basis for virtual commercial transactions. The method for the mobile game using a portable terminal includes: receiving, by the portable terminal, current location information of the portable terminal; transmitting, by the portable terminal, the received current location information to a game server; receiving, by the portable terminal, item information corresponding to the current location information from the game server; receiving, by the game server, item modified information from the portable terminal; and updating, by the game server, the item information by reflecting the received item modified information.

### CLAIM OF PRIORITY

This application claims the benefit of priority under 35 U.S.C. §119 from Korean patent application No. 10-2009-0010990 filed on Feb. 11, 2009, the contents of which are herein incorporated by reference in its entirety.

### BACKGROUND OF THE INVENTION

1. Field of the Invention

The present invention relates to a method and a system for a mobile game using a location-based service. More particularly, the present invention relates to a method and a system for a mobile game using a location-based service.

2. Description of the Related Art

A portable terminal is now considered by many people to be a necessity of modern life, and there has been a rapid increase in sales of such devices. Such a portable terminal has functionally changed over time from primarily a voice communication unit into a multimedia communication device because newer portable terminal provide various kinds of data transmission services and various supplementary services as well as a voice communication service. As a multimedia communication device, a portable terminal also can perform a role of a game device, which allows a portable terminal user to play an online or offline game by downloading game contents.

Game contents executable in a portable terminal are under continuously development. Also, recently, game contents using a location-based service are under development. For example, a location-based service (LBS) indicates a service utilizing location information on where a portable terminal user is located. A service field of LBS can be said to be a characteristic that differentiates a mobile/portable terminal from other fixed devices. However, the development of game contents using such a location information service continues to have shortcomings. Until now, developed game contents have been used for very simple purposes, such as the supply of an item at a specific location. In other words, a portable terminal can passively receive information on a corresponding event when the terminal arrives at a specific location, but there is difficulty to reflect information input by a user to a game server.

The present invention provides a system and a method for a mobile game based on a location information service, which has interactivity by reflecting the information input by a portable terminal user to a game server.

### SUMMARY OF THE INVENTION

Accordingly, the present invention has been made to provide a method and a system for a mobile game using an actual location-based service of the portable terminal to provide a basis for virtual commercial transaction.

In accordance with an exemplary aspect of the present invention, there is provided a method for a mobile game using a portable terminal, the method including: receiving, by the portable terminal, current location information of the portable terminal; transmitting, by the portable terminal, the received current location information to a game server; receiving, by the portable terminal, item information corresponding to the current location information from the game server; receiving, by the game server, item modified information from the portable terminal; and updating, by the game server, the item information by reflecting the received item modified information.

In a method for mobile game, the item information may include, for example, information on a kind, a price, and a quantity of a to-be-transacted article in a virtual commercial transaction.

In a method for mobile game, the item modified information may include information on an increase or a decrease in a quantity of a to-be-transacted article in a virtual commercial transaction.

In accordance with another exemplary aspect of the present invention, there is provided a system for a mobile game using a location-based service, the system including: a portable terminal for connecting to a game server by execution of the mobile game, and for transmitting current location information of the portable terminal to the game server; and the game server for receiving the current location information of the portable terminal from the portable terminal, transmitting item information corresponding to the received current location information to the portable terminal, receiving item modified information from the portable terminal; and updating the item information by reflecting the received item modified information.

The system for the mobile game preferably includes a GPS satellite for transmitting a GPS signal including the current location information of the portable terminal.

In the mobile game using a location based service, the game has advantageously has interchangeability because a user transmits his input formation to a game server, and the game server then reflects the transmitted information to the gaming environment. This interchangeability increases the flow of the user in the game, and causes a new enjoyment factor.

### BRIEF DESCRIPTION OF THE DRAWINGS

The above and other exemplary objects, features and advantages of the present invention will become more apparent from the following detailed description taken in conjunction with the accompanying drawings, in which:

FIG. 1 illustrates an overview of a mobile game system using a location-based service (LBS) according to an exemplary embodiment of the present invention;

FIG. 2 is a block diagram illustrating a configuration of a portable terminal 100 according to an exemplary embodiment of the present invention;

FIG. 3 is a flow chart illustrating exemplary operation of a mobile game method using an LBS according to an exemplary embodiment of the present invention;

FIG. 4 is a view illustrating operation of a method according to an exemplary embodiment of the present invention;

FIG. 5a is a screen shot showing prices and quantities of the corresponding article in respective locations, based on an article list according to the exemplary embodiment of the present invention;

FIG. 5b is a screen shot showing prices and quantities of articles transacted in each location, based on a location according to the exemplary embodiment of the present invention; and

FIG. 6 is a view illustrating operation of a method in a reduced range mode, according to the exemplary embodiment of the present invention.

### DETAILED DESCRIPTION

In the present invention, ‘item information’ indicates information on a price and a quantity of a to-be-transacted article in a virtual commercial transaction within a game. During the game, at each location, articles which can be transacted are set, and the item information indicates information on the kind, price, and quantity of the article set for each location.

In the present invention, the term ‘item modified information’ indicates information on the increase or decrease in the quantity of a to-be-transacted article during a game. During the game, a portable terminal user can buy or sell an article. Herein, the portable terminal user inputs the kind and quantity of the article which he will buy or sell. When the user buys the article, the quantity of the articles available for sale in the corresponding location is reduced. When the user sells the article, the quantity of articles available for sale in the corresponding location is increased. In other words, item modified information indicates information on the quantity of the article that has been changed by the user's buying or selling of the article during the game.

In the present invention, a ‘point’ corresponds to a transaction means of a virtual commercial transaction during a game. In other words, a point corresponds to a currency defined during the game. When the game is started, a predetermined number of points are basically given to a user, and the user can use or obtain points by buying or selling an article. In the exemplary embodiment of the present invention, the points may be accumulated or deducted according to the occurrence of an event by an event occurring scenario during the game. The points accumulated according to the exemplary embodiment of the present invention may be used for calculating the ranking of game users.

Hereinafter, preferred exemplary embodiments of the present invention will be described in detail with reference to the drawings. In the following description and drawings, the same reference numerals are used to designate the same or similar components. Also, the detailed description on known functions and constructions may be omitted for clarity and conciseness of the present invention so as not to obscure appreciation of the present invention by a person of ordinary skill in the art.

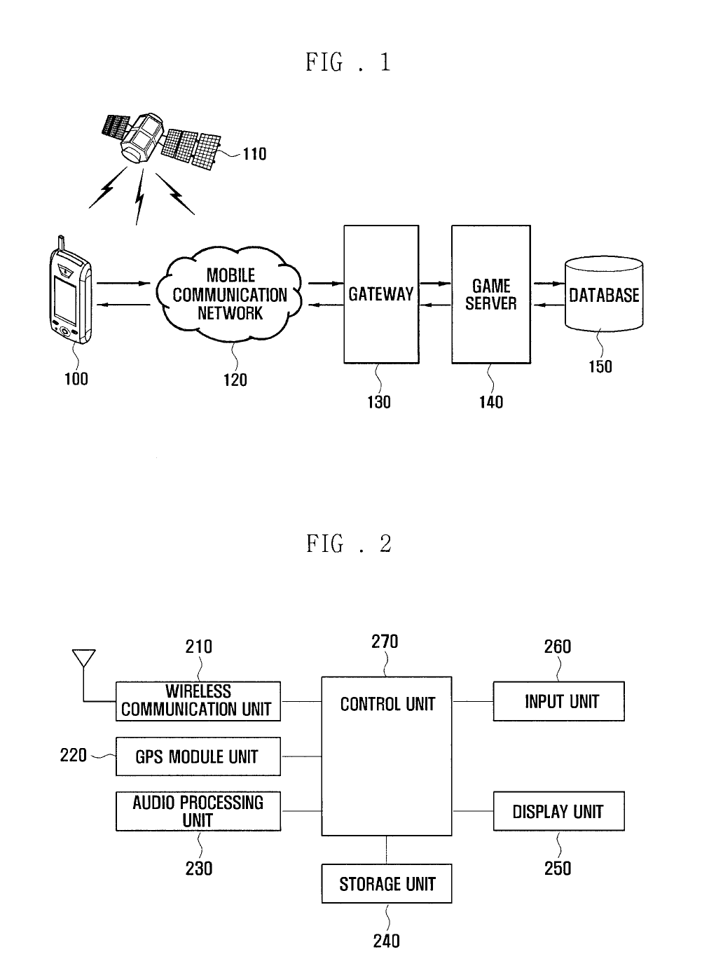

FIG. 1 is an overview illustrating a mobile game system using a location-based service (LBS) according to an exemplary embodiment of the present invention.

The mobile game system using the LBS according to the exemplary embodiment of the present invention preferably includes a portable terminal 100, a GPS satellite 110, a mobile communication network 120, a gateway 130, a game server 140, and a database 150.

The portable terminal 100 is a type of client which transmits and receives data by connecting to the game server 140, and may correspond via CDMA (Code Division Multiple Access), GSM (Global System for Mobile communication), CDPD (Cellular Digital Packet Data), TDMA (Time Division Multiple Access) to the game server or to another mobile communication terminal.

GPS satellite 110 performs the role of transmitting a GPS satellite signal to the portable terminal 100. In the case of an AGPS (Assisted-GPS), the GPS satellite 110 may transmit a GPS satellite signal to a mobile communication network base station. Also, when the portable terminal 100 can receive information on a current location of the portable terminal 100 from the mobile communication network base station, the GPS satellite 110 may be omitted from the mobile game system. The GPS satellite 110 corresponds to a satellite to which the portable terminal 100 can receive a GPS satellite signal, from among 24 satellites circling on 6 orbit planes around the earth. The GPS satellites 110 are disposed in such a manner that a user can receive GPS satellite signals from at least 5 GPS satellites, and each GPS satellite transmits 2 L-band frequencies L1 and L2. L1 carries a P-code (Precise code) and a C/A code (Coarse/Acquisition), and L2 carries a P-code.

The mobile communication network 120 performs the role of transmitting and receiving signals between the portable terminal 100 and the gateway 130. The mobile communication network 120 may preferably include, for example, a mobile switching center (MSC), a base station controller (BSC), and a base transceiver system (BTS). In the case of an AGPS (Assisted GPS), the mobile communication network 120 may further include, for example, a location server.

The gateway 130 performs the function of an interface for connecting the portable terminal 100 and the game server 140. Since it is necessary to connect to an Internet network by TCP/IP (Transmission Control Protocol/Internet Protocol) with a mobile communication network to achieve WAP (Wireless Application Protocol), the gateway 130 performs a role of connecting the Internet network to the mobile communication network. The gateway 130 may provide a conversion function, between a TCP/IP model-based HTTP (Hyper Text Transfer Protocol) protocol in a wired Internet network, and a WAP protocol in a wireless internet network, and an encoding/decoding function of a WML (Wireless Markup Language) document. When receiving a request for connection to the game server 140 of the portable terminal 100, the gateway 130 analyzes this request, receives the result of the connection request from the game server 140, encodes the result into a data format appropriate for wireless transmission, and transmits the encoded data to the portable terminal 100. The gateway 130 may preferably include an encoder, a decoder, a java package, a WTP layer (Wireless Transaction Layer, a WDP layer (Wireless Datagram Layer), and a WSP layer (Wireless Session Layer). The encoder and the decoder perform a function of converting a WML document into a binary WML appropriate for wireless transmission, and vice versa. Also, according to the present exemplary embodiment of the present invention, the gateway 130 may preferably include an inter-working function (IWF) and a packet data serving node (PDSN). The IWF provides an interface for data interchange between a wireless communication system and a wired communication system, and performs a function of converting a protocol, a signal, and data into other formats appropriate for each network. The PDSN collects data transmitted from a wireless communication network to generate packet data, and transmits the packet data to the game server 140 via an internet network.

The game server 140 typically performs a role of providing a virtual commercial transaction game service according to a present exemplary embodiment of the present invention. When receiving information on a current location of the portable terminal 100, the game server 140 preferably extracts item information corresponding to this location from the database 150 and transmits the information to the portable terminal 100. The item information includes information on the kind (type), price and quantity of a to-be-transacted article in a virtual commercial transaction. When receiving item modified information from the portable terminal 100, the game server 140 updates the previously stored item information by reflecting the received item modified information. The item modified information includes information on the increase or decrease in the quantity of a to-be-transacted article in a virtual commercial transaction. The game server 140 updates the price of the to-be-transacted article of the virtual commercial transaction when the item information is updated. For example, when a user buys a large number of specific articles, the game server 140 may raise the price of the corresponding article. On the other hand, when a user sells a large number of specific articles, the game server 140 may lower the price of the corresponding article.

In updating the price of an article, the game server 140 may reflect other price changing factors. For example, the game server 140 may reflect other price changing factors in determining the price of an article according to a previously-set price changing scenario. The other price changing factors may include the addition of a new kind of article, export, import, or the like. For example, in the case where a new kind of article is added as a to-be-transacted object according to a previously-set price changing scenario, the price of an existing article may be lowered. The game server 140 determines the price of an article by reflecting these factors. Also, in the case where a large number of specific articles are exported to foreign countries according to a price changing scenario, since the quantity of the corresponding articles kept within the country is reduced, the game server 140 may raise the price of the corresponding article according to this factor.

Also, the game server 140 performs a role of updating point information corresponding to a transaction means of a virtual commercial transaction according to the item modified information. A game user may buy or sell an article within a virtual commercial transaction. When the user buys an article, the game server 140 reduces the points possessed by the user, and when the user sells an article, the game server 140 increases the points possessed by the user. The game server 140 can store data on the points possessed by a game service user in the database 150, and calculate the ranking of game users in a higher point order.

The database 150 preferably performs a role of storing data required for operating a game. The database 150 stores information on the kinds, prices, and quantities of articles available for commercial transaction in each location registered within the game. Also, the database 150 stores a price changing scenario related to the occurrence of other price changing factors. The database 150 also performs a role of storing the information on points possessed by a game user, and the ranking of game users.

FIG. 2 is a block diagram illustrating the configuration of the portable terminal 100 according to an exemplary embodiment of the present invention.

Referring now to FIG. 2, a wireless communication unit 210 performs a function of transmitting/receiving the corresponding data for wireless communication of a portable terminal. The wireless communication unit 210 may include an RF transmitter, an RF receiver, and the like. The RF transmitter preferably up-converts and amplifies a frequency of a transmitted signal, and the RF receiver preferably low-noise amplifies a received signal and down-converts the frequency of the received signal. Also, the wireless communication unit 210 may receive data via a wireless channel, output the data to a control unit 270, and transmit the data output from the control unit 270 via a wireless channel. The wireless communication unit 210 according to the exemplary embodiment of the present invention may preferably receive information on a current location of the portable terminal 100 via the mobile communication network 120. The wireless communication unit 210 may preferably transmit information on a current location of the portable terminal 100 to the game server 140 via the mobile communication network 120. Also, the wireless communication unit 210 receives item information corresponding to the current location of the potable terminal 100 from the game server 140 via the mobile communication network 120. When a user buys or sells an article within a game, the wireless communication unit 210 transmits the information on the article bought or sold by the user to the game server 140 via the mobile communication network 120.

A GPS module unit 220 performs a role of receiving a GPS satellite signal from the GPS satellite 110. The GPS module unit 220 is largely divided preferably into a high frequency unit and a signal processing unit. The high frequency unit converts a 1.2 GHz or 1.5 GHz signal received by an antenna into a low frequency signal which is easy to handle. The signal processing unit obtains a message received from a satellite, and a pseudo-range by recovering a spread spectrum into its original one through the inverse conversion. The GPS module unit 220 according to the present exemplary embodiment of the present invention receives information on a current location of the portable terminal through the GPS satellite signal received from the GPS satellite 110, and then transmits the information to the control unit 270. When the portable terminal 100 receives the information on a current location of the portable terminal 100 via the mobile communication network 120, according to the exemplary embodiment, the GPS module unit 220 may be omitted from the configuration of the portable terminal 100.

Still referring to FIG. 2, an audio processing unit 230 may include codecs, and the codecs include a data codec for processing packet data, etc., and an audio codec for processing audio signals, such as a voice. The audio processing unit 230 converts a digital audio signal into an analog audio signal through an audio codec, reproduces the converted signal through a speaker SPK, and converts an analog audio signal input from a microphone MIC into a digital audio signal through an audio codec. When the portable terminal 100 transmits/receives data to/from the game server 140, the audio processing unit 230 according to the exemplary embodiment of the present invention may output sound effects related to the transmission/reception. For example, the audio processing unit 230 may output sound effects corresponding to the cases where the portable terminal 100 starts a game by connecting to the game server 140, a commercial transaction is completed by a user's buying or selling of an article, or points possessed by a user are increased or decreased. When hearing the sound effects, the user can check for the completion of the commercial transaction, and the increase or decrease in the points.

A storage unit 240 stores programs and data required for operating a portable terminal, and may be divided, for example, into a program area and a data area. The storage unit 240 according to the exemplary embodiment of the present invention performs a role of storing programs and data required for executing a game. The control unit 270 connects to the game server 140 by executing the game-related programs stored in the storage unit 240 and controlling the wireless communication unit 210. The storage unit 240 may store information on the points and articles possessed by a user. Although the points possessed by the user are stored in the database 150 by the game server 140, the control unit 270 stores the information on the points and articles possessed by the user in the storage unit 240, too, so that the user can check the information on his currently possessed points and articles without the connection to the game server 140. Also, the storage unit 240 may store information on the user's transaction details.

A display unit 250 may preferably include a liquid crystal display (LCD), or other type of thin film technology screen, and visually provides, to a user, a menu of the portable terminal 100, input data, function setting information, and other various information. For example, the display unit 250 performs a function of outputting a booting screen, a stand-by screen, a display screen, a communication screen, and other application execution screens of the potable terminal 100. The display unit 250 according to this exemplary embodiment of the present invention performs a role of displaying item information received from the game server 140. A user determines the kind and quantity of an article that he wants to buy or sell through the item information displayed on the display unit 250. Also, the display unit 250 performs a role of displaying the game users' point ranking information received from the game server 140.

An input unit 260 receives the input of a user's key operation signal for controlling the portable terminal 100, and transfers the input to the control unit 270. The input unit 260 may preferably include a keypad having alphanumeric keys, and directional keys, or may include a touch pad when the portable terminal is based on a touch screen. Also, when the portable terminal is provided with an image sensor, an acceleration sensor, or the like, the above mentioned sensors may be included in the input unit 260. According to the exemplary embodiment of the present invention, a user may input the command for buying or selling an article within a game, through the input unit 260.

The control unit 270 performs a function of controlling the overall operation of the portable terminal. The control unit 270 according to the exemplary embodiment of the present invention control executing game-related programs stored in the storage unit 240. The control unit 270 controls connecting to the game server 140 by controlling the wireless communication unit 210. The control unit 270 performs a role of transmitting the portable terminal 100's current location information received from the GPS module unit 220 to the game server 140 by controlling the wireless communication unit 210. According to the exemplary embodiment of the present invention, the control unit 270 can receive the current location information of the portable terminal 100 and transmit the information to the game server 140 by controlling the wireless communication unit 210. When a user inputs the command for buying or selling an article through the input unit 260, the control unit 270 transmits the information about the article bought or sold by the user to the game server 140 by controlling the wireless communication unit 210. The control unit 270 receives the updated article information from the game server 140 by controlling the wireless communication unit 210. The control unit 270 may receive information about 0the game users' point ranking from the game server 140 by controlling the wireless communication unit 210.

The above description has been about the configuration of the mobile game system using an LBS, and the configuration of the portable terminal included in the same system. Hereinafter, a mobile game method using the LBS will now be described.

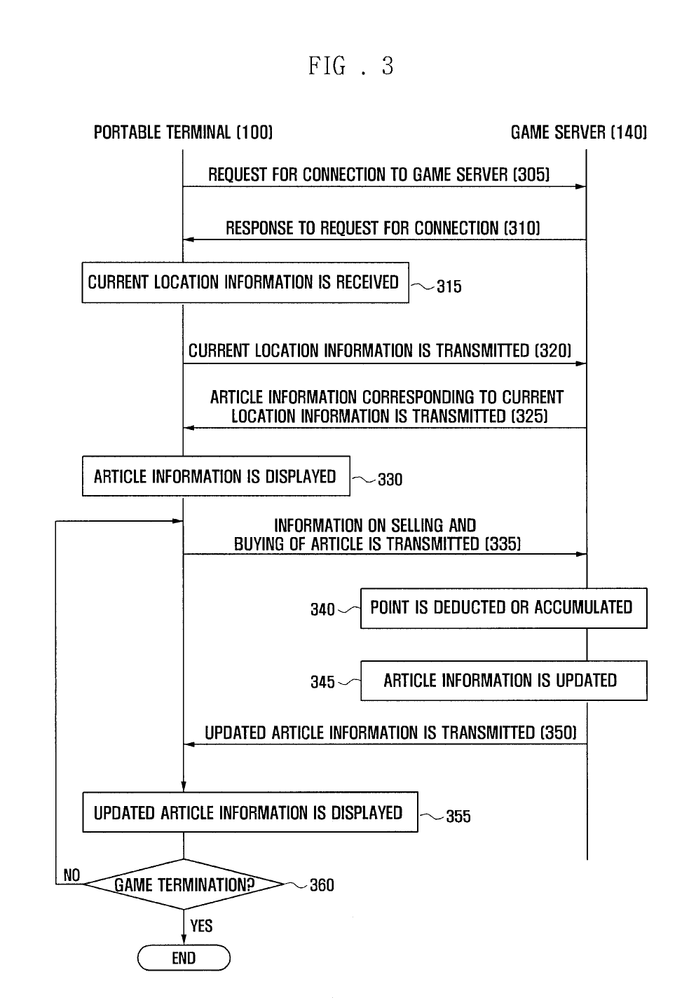

FIG. 3 is a flow chart illustrating a mobile game method using an LBS according to the exemplary embodiment of the present invention. In FIG. 3, the process of a mobile game will be described by focusing on the portable terminal 100 and the game server 140.

When a user uses a mobile game service, typically a mobile game-related program provided in the portable terminal 100 is executed. The user inputs a command for executing the mobile game-related program through the input unit 260, and the control unit 270 executes a mobile game program stored in the storage unit 240.

In step 305, the control unit 270 of portable terminal 100 makes a request for connection to the game server 140 via the mobile communication network 120 and the gateway 130 by controlling the wireless communication unit 210. When a user inputs a user ID and a password via the input unit 260, the control unit 270 transmits the input information on the user ID and the password to the game server 140 via the wireless communication unit 210. The game server 140 performs user authentication through the received information on the user ID and the password, and permits the connection of the portable terminal 100.

In step 310, in response to the connection request of the portable terminal 100, the game server 140 transmits a notification indicating that the connection is permitted to connect with the portable terminal 100.

In step 315, the portable terminal 100 obtains current location information of the portable terminal 100. The control unit 270 may receive, for example, a GPS satellite signal from the GPS satellite 110 by controlling the GPS module unit 220, and thereby obtains the current location information of the portable terminal 100. According to the exemplary embodiment of the present invention, the control unit 270 may receive a radio signal from the mobile communication network 120 by controlling the wireless communication unit 210, and thereby obtains the current location information of the portable terminal 100. Otherwise, the control unit 270 may receive assistant data from the mobile communication network 120 and a GPS satellite signal from the GPS satellite 110 through the control of the wireless communication unit 210, and thereby obtains the current location information of the portable terminal 100.

In step 320, the control unit 270 transmits the current location information of the portable terminal 100 to the game server 140. After checking the current location information of the portable terminal 100, the game server 140 extracts the corresponding article information (item information) from the database 150, and transmits the item information to the portable terminal 100. In the database 150, the information on articles transacted in each location defined in the game is stored. The article information includes information on the kinds, prices and quantities of articles transacted in each location. For example, when a user connects to a game in Pusan, the game server 140 transmits information on the list, prices, and quantities of articles transacted in Pusan, from among articles defined in the game, to the portable terminal 100.

At step 325, when transmitting the article information to the portable terminal 100, the game server 140 may transmit information on points and articles possessed by the portable terminal 100, together with information on the current time. In addition, the game server 140 may transmit information on the articles that can be sold in the current location of a user. At step 330, the portable terminal 100 displays the article information received from the game server 140 on the display unit 250. After checking the article information displayed on the display unit 250, the user may input the command for buying or selling an article via the input unit 260.

According to the exemplary embodiment of the present invention, the control unit 270 may check, for example, the current location information by controlling the wireless communication unit 210 or the GPS module unit 220, and then displaying a message for selecting to buy or sell an article by controlling the display unit 250. Herein, when a user selects to sell an article, the control unit 270 transmits the current location information of the portable terminal 100 through the control of the wireless communication unit 210 while making a request for the information on points and articles possessed by the user. Then, when receiving the information on points and articles possessed by the user from the game server 140, the control unit 270 may display the information on points and articles on the display unit 250. If the user selects to buy an article, the control unit 270 transmits the current location information of the portable terminal 100 through the control of the wireless communication unit 210 while making a request for the information on articles that are being sold at the current location. Then, when receiving the information on articles which are being sold at the current location from the game server 140, the control unit 270 may display this information on the display unit 250.

When a user wants to buy an article, he selects the kind and quantity of the article. The control unit 270 transmits the article purchasing information input by the user to the game server 140 by controlling the wireless communication unit 210.

With continued reference to FIG. 3, at step 340 the game server 140 then deducts the points corresponding to a purchasing price of the user, and increases the number of articles possessed by the user. For example, when a user inputs a command for buying 5 milmyeons (each of which corresponds to 100 points), the game server 140 deducts 500 points from the user's points, and increases the number of milmyeons possessed by the user by 5. Likewise, when a user sells an article, the game server 140 decreases the number of articles possessed by the user, and increases the points possessed by the user.

At step 345, the game server 140 updates the article information according to the buying or selling of an article. This update corresponds to a price adjusting step in a commercial transaction. When a user buys a specific article, the quantity of the specific article possessed in the corresponding location is reduced. Herein, in the specific article, when the purchased amount is more than the production volume and the increased amount by the user's selling, the scarcity value of the specific article is increased, thereby increasing the price. The game server 140 adjusts the price of the specific article by considering factors including the production volume, the increased amount by the user's selling, and the user's purchased amount on a specific article. For example, in the case of 5000 milmyeons possessed in Pusan, when a user buys 5 milmyeons in Pusan, the quantity of milmyeons possessed in Pusan is reduced to 4995, and the game server 140 raises the price of a milmyeon according to the reduction of the milmyeon possession amount.

At step 350, the game server 140 transmits the article information updated to the portable terminal 100. The updated article information, which is displayed at step 355, may include information on the adjusted article price as well as the added article by a user's selling. For example, despite the fact that an apple is not included in a transaction item list in Pusan, in the case where an apple can be sold in Pusan according to the scenario stored in the database 150, when a user sells an apple in Pusan, the apple is additionally included in an article list. As described above, when a user buys or sells an article in the corresponding location, the game server 140 updates the article information and transmits the updated information to the portable terminal 100. The control unit 270 displays the updated article information by controlling the display unit 250. As the user continues to buy and sell an article in the corresponding location, the game server 140 updates the article information according to the user's buying or selling of an article, and transmits the updated information to the portable terminal 100.

According to an exemplary embodiment of the present invention, when a user connects to a game in a predetermined location, and moves to another location during the connection to the game, the control unit 270 may check information regarding the new location via the GPS module unit 220 or the wireless communication unit 210, and transmit the checked information regarding the new location to the game server 140. When receiving the new current location information of the portable terminal 100, the game server 140 transmits the article information corresponding to (i.e. associated with) this new current location information to the portable terminal 100.

At step 360, when a user inputs a command for terminating the game via the input unit 260, the control unit 270 cuts off the connection to the game server 140 by controlling the wireless communication unit 210, and terminates the execution of a game-related program. The user checks the article information corresponding to each location defined within a game by actually moving, and buys or sells articles in a virtual commercial transaction while saving up the margin between a purchasing price and a selling price as points.

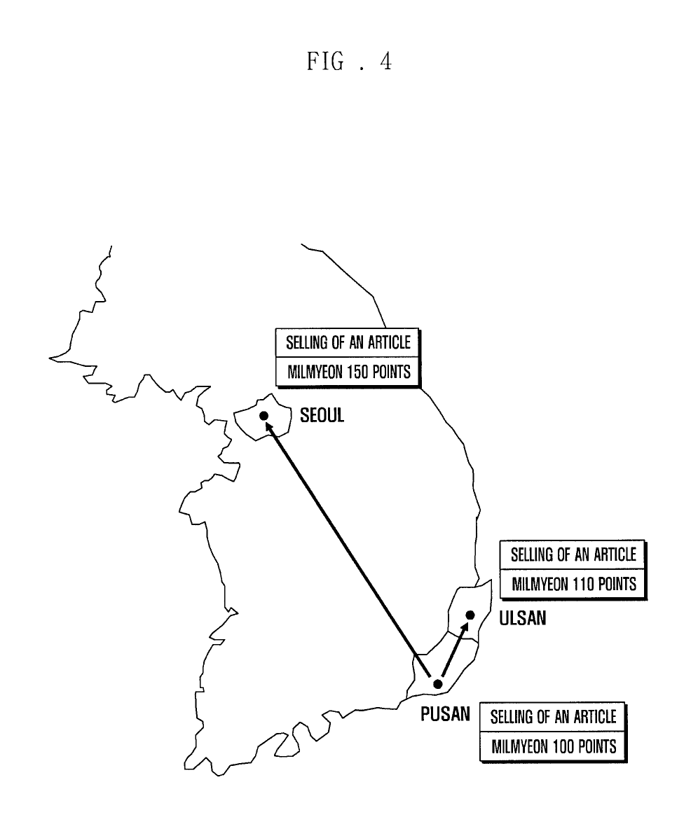

FIG. 4 is a view illustrating an exemplary aspect of a function of a game in a method according to an exemplary embodiment of the present invention. In FIG. 4, a map of Korea is illustrated. This is a real-world map on which a user of a portable terminal actually moves. As examples of commercial transaction locations defined within the game, Seoul, Pusan, and Ulsan are illustrated. In the game defined in the exemplary embodiment of the present invention, although a game user actually moves to Seoul, Pusan, and Ulsan, the buying or selling of an article is performed in the virtual commercial transaction defined within the game.

For example, in the case where a milmyeon is defined to be transacted in Seoul, Pusan, and Ulsan, a game user when actually located in any of the three locations, can transact the milmyeon in the virtual commercial transaction. The respective locations may have the same or different milmyeon prices. The article price is determined by the game server 140, and the game server 140 determines the article price by considering if the transaction location is the origin of the corresponding article, the distance of the transaction location from the origin, and the corresponding article's quantity possessed by the current transaction location. For example, when the origin of milmyeon is Pusan, the game server 140 determines the price of the milmyeon in Pusan to be lower than those in other locations. Also, the game server 140 determines a milmyeon price to be higher in a location possessing a smaller quantity of milmyeon, compared to in a location possessing a larger quantity of milmyeon. The article price is determined by an article price scenario stored in the database 150.

In FIG. 4, it is assumed that a user, actually located in Pusan, bought 10 milmyeons (each of which corresponds to 100 points) by executing a game function. Then, the user sold 5 milmyeons at a price of 110 points per milmyeon by moving to Ulsan. Then, the user sold 5 milmyeons at a price of 150 points per milmyeon by moving to Seoul. The user spent 1000 points to buy 10 milmyeons, and obtained 1300 points by buying 10 milmyeons to Ulsan and Seoul. As a result, the user obtained 300 points as profit. After buying an article in a lower price location for the corresponding article, the user can sell the purchased article by moving to a higher price location, and thus accumulate the margin as points.

According to an exemplary embodiment of the present invention, a user can receive information on prices of articles from the game server 140. Since the user, who knows a lower price location and a higher price location, can accumulate points through the commercial transactions, it is necessary to previously check the price information of each location.

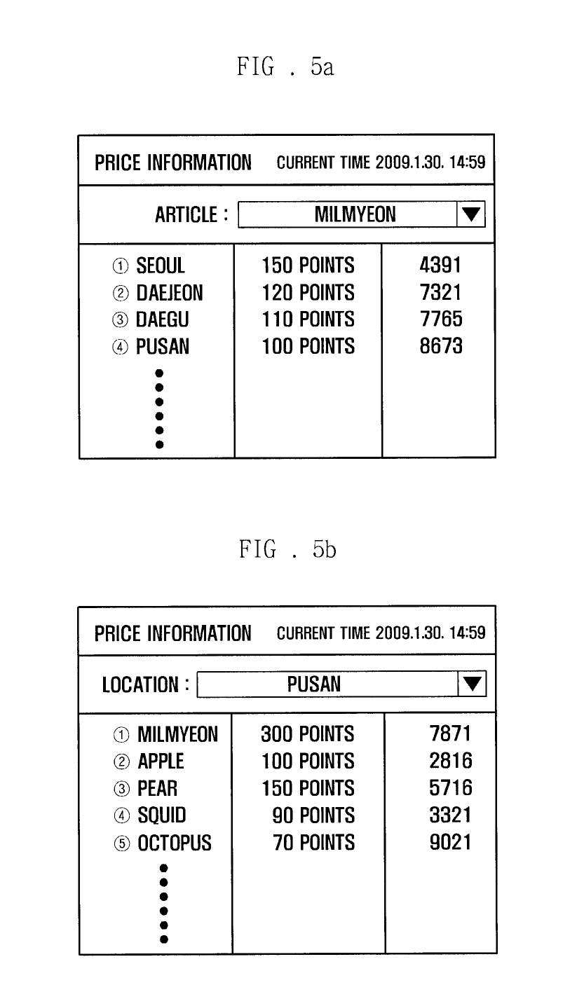

FIG. 5a is a screen shot showing one way how prices and quantities of the corresponding article in respective locations can be displayed, based on an article list according to the exemplary embodiment of the present invention. When the control unit 270 transmits a request for price information on milmyeon to the game server 140 by controlling the wireless communication unit 210, the game server 140 transmits the price information on the milmyeon to the portable terminal 100. Then, the control unit 270 displays the received information by controlling the display unit 250. In FIG. 5a, an article is selected as milmyeon, and the prices and quantities of the milmyeon in the locations of Seoul, Daejeon, Daegu, Pusan, and the like are displayed. Also, in FIG. 5a, the information on a current time is displayed. Since the article price can be changeable in real-time, the current time information is provided to a user so that he can confirm the currently displayed price information is on the information of the current time. According to the exemplary embodiment of the present invention, the game server 140 may transmit the information of the past price to the portable terminal 100 in response to the request of the user. When the information of the past price is stored in the storage unit 240, the control unit 270 may extract the information of the past price from the storage unit 240, and display the extracted information on the display unit 250. Also, the user may check the changes of an article price by comparing the current price information to the past price information.

FIG. 5b is a screen shot showing one way a portable terminal may display prices and quantities of articles transacted in each location, based on a location according to an exemplary embodiment of the present invention. In FIG. 5b, the location is selected as Pusan, and the prices and quantities of articles transacted in Pusan (a milmyeon, an apple, a pear, a squid, an octopus, and the like) are displayed. In the same manner as described in FIG. 5a, the current time is displayed in FIG. 5b, which allows a user to confirm that the currently displayed price information is on the information of the current time.

Although the game exemplified in FIG. 4 is over the entirety of Korea, another game over a narrower location may be considered. For example, since Seoul is divided into Kangnam-gu, Seocho-gu, and the like by a “gu” unit, the kinds, prices, and quantities of to be transacted articles may be differently set for respective locations. In addition, a larger area, such as the European Union, may be provided as a geographic boundary. Thus, a game user may enjoy the game by moving between various locations within Seoul, or conversely, various countries within the continent of Asia. After buying an article via a virtual commercial transaction by connecting to a game in Kangnam-gu, the game user may move to Seocho-gu where the corresponding article's price is higher and sell the article. In this case, he can obtain the margin.

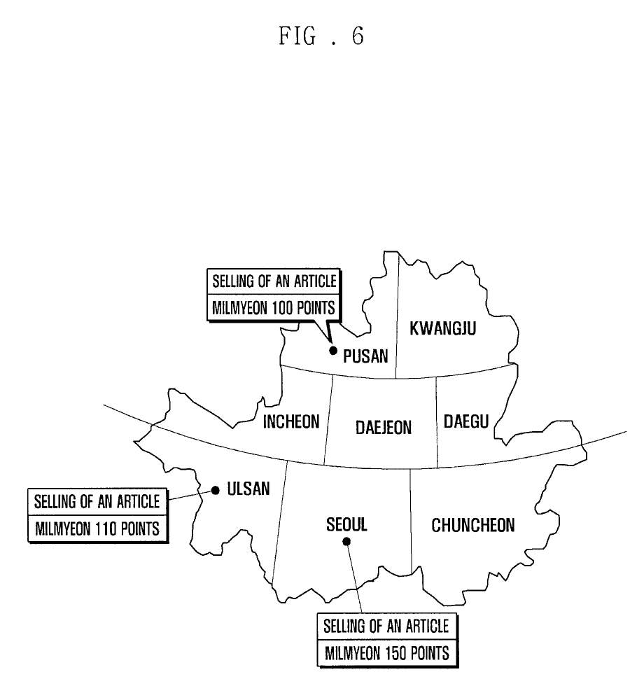

According to an exemplary embodiment of the present invention, a wide ranging location may be reduced to a more narrow ranging location. FIG. 6 is a view illustrating operations of a game according to a method of the invention in a reduced range mode, according to the exemplary embodiment of the present invention. In FIG. 6, transaction locations are reduced from the entirety of Korea to the area within Seoul. A user's movement over the entirety of Korea may be vexatious in the process of a game. In this case, when the game operates in a reduced range mode, the user can achieve the effect of movement over the whole of Korea without escaping Seoul. In other words, Seoul is divided into predetermined areas, and the transaction locations over the entirety of Korea are substituted for the predetermined areas one-by-one. A user may buy a milmyeon at an area corresponding to Pusan and sell the milmyeon at another area corresponding to Ulsan and Seoul in FIG. 6, which may achieve the same effect as that of the buying of a milmyeon in Pusan and the selling of the milmyeon in Seoul and Ulsan in FIG. 4. The game server 140 may distinguish the reduced range mode from a normal mode, by raising a purchasing price or lowering a selling price in a commercial transaction in the reduced range mode compared to the normal mode.

In the present invention, an additional charge, a discount charge, and other price fluctuation factors may be applied. The additional charges may include a sales tax, a local premium, or the like. In other words, the game server 140 may impose a predetermined ratio of a purchasing price or a selling price as a tax when a user buys or sells an article within a game. Also, if a transacted article is a regional special product, the game server 140 may impose a premium on the transacted article, thereby allowing the article to be transacted at a higher price than other articles.

The discount charges may include, for example, a bulk purchasing discount, a movement distance discount, or the like. The discounts facilitate the revitalization of a commercial transaction, thereby allowing a user to actively perform buying and selling. The game server 140 may apply a predetermined discount rate to the case in which a user buys articles in a large quantity, and apply a predetermined discount rate according to the movement distance or the number of times of movements.

Other price fluctuation factors may include, for example, the addition of a new article, the occurrence of import or export of an article, the global economy situation, or the like. Other price fluctuation factors are applied according to a price information scenario (price changing scenario) stored in the database 150. When a new article added to a specific location can substitute an existing article, the price of the existing article may be lowered. For example, when a “B” model car is newly added to an article list on which an A model car has existed, the price of the A model car may be lowered.

Also, in the case of where an article is imported or exported from/to foreign countries, the article price may be changed. For example, if a large quantity of milmyeons are imported from foreign countries, the price of a milmyeon is lowered. Also, in a state where the price of the milmyeon is lowered due to a great production volume of milmyeons, if a large quantity of milmyeons are exported to the foreign countries, the price of the milmyeon is raised again. The game server 140 may apply the corresponding factors to an article price according to a number of different article price scenarios. Also, when a war breaks out or a global economic slump occurs, the game server 140 may reflect this situation to the article price according to the price information scenario. When a war begins, an oil price or a raw material price may be raised. Accordingly, from among articles transacted in respective locations, the prices of some articles influenced by the oil price or the raw material price are raised. Besides, in order to inhibit the monopoly and oligopoly of a specific user, it is possible to set a limited quantity per purchase, a limited quantity per day, or the like.

The game server 140 manages points of the respective game-connected users, and stores the points in the database 150. The game server 140 may calculate the point ranking of game users and inform them of the ranking.

The exemplary embodiments of the present invention disclosed in the present specification and drawings are merely illustrative, and not restrictive. Those skilled in the art will appreciate that various modifications, additions and substitutions are possible, without departing from the scope and spirit of the invention as disclosed in the accompanying claims.

What is claimed is:

1. A method for a mobile game using a portable terminal, the method comprising
receiving, by the portable terminal, current location information regarding a physical location of the portable terminal;
transmitting, by the portable terminal, the received current location information to a game server;
receiving, by the portable terminal, item information associated with the current location information from the game server;
receiving, by the game server, item modified information from the portable terminal including at least one modification of the item information; and
updating, by the game server, the item information to reflect the item modified information received by the game server.

2. The method for the mobile game as claimed in claim 1, wherein the item information comprises information on a kind, a price, and a quantity of a to-be-transacted article in a virtual commercial transaction based on the physical location of the portable terminal.

3. The method for the mobile game as claimed in claim 2, wherein the item modified information comprises information on an increase or a decrease in the quantity of the to-be-transacted article in the virtual commercial transaction.

4. The method for the mobile game as claimed in claim 2, wherein in updating the item information, information on the price of the to-be-transacted article in the virtual commercial transaction is updated.

5. The method for the mobile game as claimed in claim 1, wherein updating the item information further comprises updating item information according to a price change-related scenario previously set by the game server.

6. The method for the mobile game as claimed in claim 1, further comprising updating point information associated with a transaction means of a virtual commercial transaction according to the item modified information, by the game server.

7. The method for the mobile game as claimed in claim 6, further comprising calculating a ranking by the game server of at least one portable terminal which was connected or is connected to the game server, according to the point information.

8. The method according to claim 2, wherein when the portable terminal changes locations, at least one of said kind, price, and quantity of the to-be-transacted article in the virtual commercial transaction changes based on the physical location of the portable terminal.

9. The method according to claim 1, wherein the physical location of the portable terminal provided to the game server is determined by a Global Positioning System (GPS).

10. A system for a mobile game using a location-based service, the system comprising
a portable terminal for connecting to a game server when the mobile game is operating, and for transmitting current location information of the portable terminal to the game server; and
the game server for receiving the current location information of the portable terminal from the portable terminal, transmitting item information to the portable terminal associated with the received current location information to the portable terminal, receiving item modified information from the portable terminal; and updating the item information to reflect the received item modified information.

11. The system for the mobile game as claimed in claim 10, further comprising a Global Positioning System (GPS) satellite for transmitting a GPS signal comprising the current location information of the portable terminal.

12. The system for the mobile game as claimed in claim 10, wherein the item information comprises information on a kind, a price, and a quantity of a to-be-transacted article in a virtual commercial transaction.

13. The system for the mobile game as claimed in claim 12, wherein the item modified information comprises information on an increase or a decrease in the quantity of the to-be-transacted article in the virtual commercial transaction.

14. The system for the mobile game as claimed in claim 12, wherein the game server updates information on the price of the to-be-transacted article in the virtual commercial transaction based on the physical location of the portable terminal.

15. The system for the mobile game as claimed in claim 10, wherein the game server updates point information corresponding to a transaction means of a virtual commercial transaction according to the item modified information.

16. The system according to claim 12, wherein when the portable terminal changes locations, at least one of said kind, price, and quantity of the to-be-transacted article in the virtual commercial transaction changes based on the physical location of the portable terminal.
